(19) United States
(12) Patent Application Publication
(10) Pub. No.: US 2011/0139284 A1
(43) Pub. Date: Jun. 16, 2011

(54) DILUTED-FLUID DISPENSING DEVICE WITH PRESSURE-COMPENSATING PASSIVE VALVE

(75) Inventor: John J. Dyer, Shoreview, MN (US)

(73) Assignee: 3M Innovative Properties Company

(21) Appl. No.: 12/637,799

(22) Filed: Dec. 15, 2009

(51) Int. Cl. B01F 5/04; B01F 3/08; B67D 7/74

(52) U.S. Cl. 137/892; 137/888; 137/895; 137/101.11; 222/145.1

(57) ABSTRACT

Herein is disclosed a diluted-fluid dispensing device that operates on the venturi principle to mix a concentrate with a diluent. A pressure-compensating passive valve is provided in a fluid passage of the device through which diluent flows, in order to enhance the precision of the dilution over a range of pressure and/or flowrate at which diluent may be supplied to the device. The passive valve may be placed in proximity to the diluent inlet of the device. The passive valve may be a self-actuating valve.

### BACKGROUND

It is often desired to mix a concentrate with a diluent, e.g. for purposes of making diluted cleaning mixtures and the like. For such purposes, it is common to use venturi-type mixing systems in which the flow of a diluent through a first passage causes a concentrate to be drawn through a second passage that intersects into the first passage so as to mix the concentrate with the diluent and to produce a stream of diluted fluid.

### SUMMARY

Herein is disclosed a diluted-fluid dispensing device that operates on the venturi principle to mix a concentrate with a diluent. A pressure-compensating passive valve is provided in a fluid passage of the device through which diluent flows, in order to enhance the precision of the dilution over a range of pressure and/or flowrate at which diluent may be supplied to the device. The passive valve may be placed in proximity to the diluent inlet of the device. The passive valve may be a self-actuating valve.

Thus, in one aspect, herein is disclosed a diluted-fluid dispensing device comprising: first fluid-flow passage fluidly connecting a diluent inlet to a diluted-fluid outlet; a second fluid-flow passage intersecting with the first fluid-flow passage and fluidly connecting a concentrate inlet to the intersection of the second fluid-flow passage with the first fluid-flow passage; wherein the first and second fluid-flow passages collectively form a venturi; and wherein the first fluid-flow passage comprises a self-actuating passive pressure-compensating valve.

Thus, in another aspect, herein is disclosed a diluted-fluid dispensing device comprising: a first fluid-flow passage fluidly connecting a diluent inlet to a diluted-fluid outlet; a second fluid-flow passage intersecting with the first fluid-flow passage and fluidly connecting a concentrate inlet to the intersection of the second fluid-flow passage with the first fluid-flow passage; wherein the first and second fluid-flow passages collectively form a venturi; and wherein the first fluid-flow passage comprises a passive pressure-compensating valve in a location proximal to the diluent inlet.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a side schematic cross sectional view of an exemplary diluted-fluid dispensing device, comprising an exemplary pressure-compensating passive valve as disclosed herein.

FIG. 2 is a side perspective exploded view of an exemplary pressure-compensating passive valve and first and second retainers.

Like reference numbers in the various figures indicate like elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, bottom”, “upper”, lower”, “under”, “over”, “front”, “back”, “outward”, “inward”, “up” and “down”, and “first” and “second” may be used in this disclosure, it should be understood that those terms are used in their relative sense only unless otherwise noted.

### DETAILED DESCRIPTION

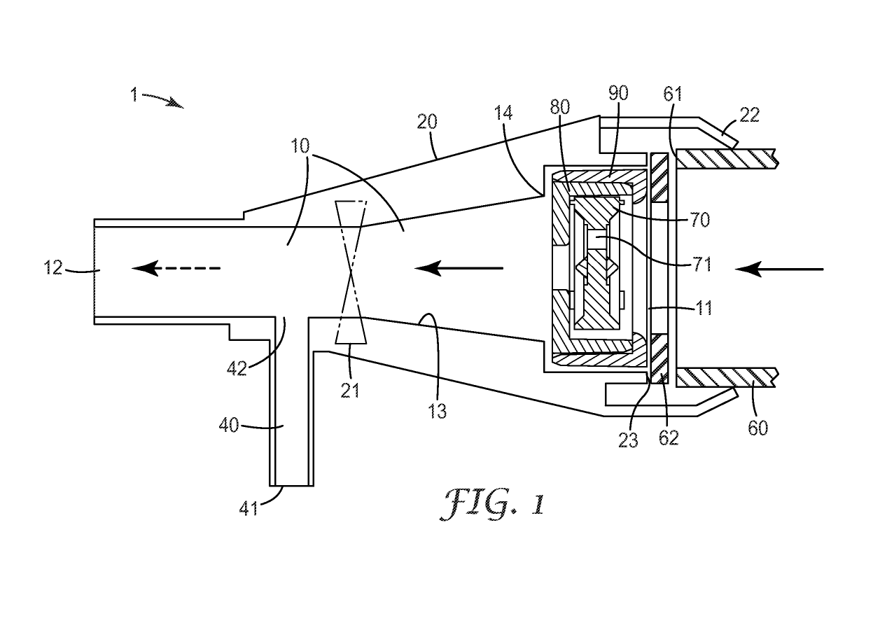

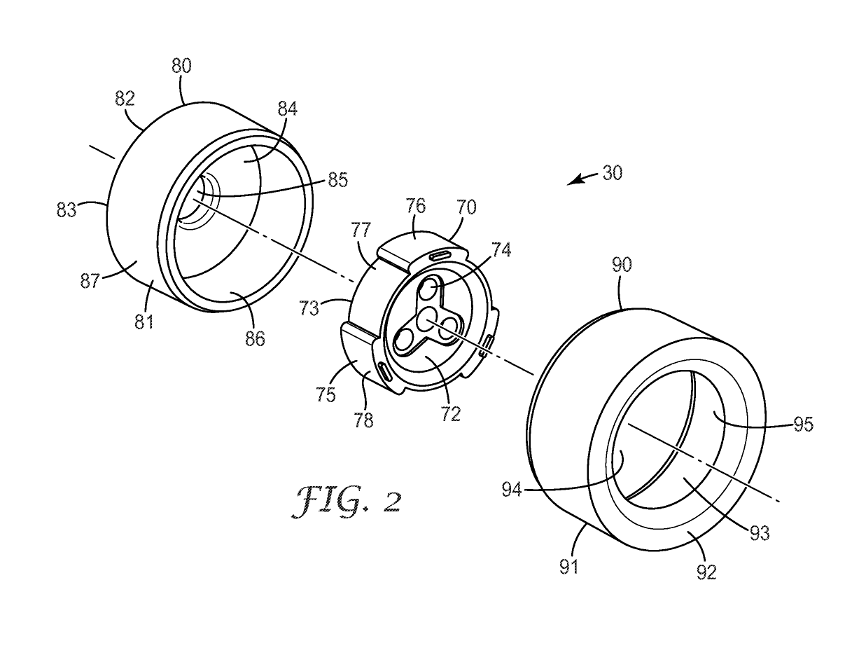

Reference is made to FIGS. 1-2 in order to illustrate exemplary embodiments of the disclosures presented herein. Shown in FIG. 1 is a simplified representative side cross sectional view of an exemplary diluted-fluid dispending device 1. Device 1 comprises main body 20 which comprises first fluid-flow passage 10 that extends through main body 20 from a first end to a second end (e.g., generally along a longitudinal axis of main body 20). First fluid-flow passage 10 fluidly connects diluent inlet 11 of main body 20 to diluted-fluid outlet 12 of main body 20. (In this instance the term fluidly connected is used broadly so as to include situations in which fluid flow down passage 10 is interruptable e.g. by an active valve or the like). Main body further comprises second fluid-flow passage 40 that penetrates partially through main body 20 so as to form intersection 42 with first passage 10 and to fluidly connect intersection 42 with concentrate inlet 41. First and second fluid-flow passages 10 and 40 combine to collectively form a venturi arranged so that flow of diluent through first passage 10 causes concentrate to be drawn from concentrate inlet 41 and to flow through second passage 40 so as to mix with the diluent at intersection 42 so as to form a diluted fluid which may then exit device 1 through diluted-fluid outlet 12. As such, passage 10 may be configured, e.g. particularly in the portion near intersection 42, to enhance the venturi effect (for example, one or more portions of passage 10 may be constricted so as to increase the linear velocity of the fluid in that portion of the passage; and/or, one or more portions may be expanded, etc. according to the well-known principles of constructing venturis).

Flow of diluent in FIG. 1 is represented by the solid arrow, with flow of diluted fluid being represented by the dashed arrow. As used herein with regard to components of device 1, upstream signifies a direction from which the diluent is moving (e.g., a direction toward diluent inlet 11), and downstream signifies a direction in which the diluent is moving (e.g., toward diluted-fluid exit 12). Herein, portions of first fluid-flow passage 10 upstream from intersection 42 may be described by the term diluent passage, and portions downstream from intersection 42 may be described by the term diluted-fluid passage.

Although in the simplified representation of FIG. 1 fluid passage 10 is shown as passing generally straight through main body 20 from diluent inlet 11 to diluted-fluid outlet 12 in linear fashion, passage 10 may comprise one or more bends, chambers, and the like (e.g., so as to permit or enhance the functioning of active valves mentioned later herein).

Those of ordinary skill in the art will appreciate that for convenience of presenting the inventive concepts herein, device 1 is drawn in a representative, simplified form. Thus, various well-known features and functionalities that are not shown in FIG. 1 may be present. For example, concentrate inlet 41 may connect (e.g., by a dip tube) to a reservoir (not shown) containing concentrate. The connection may be made by any desired mechanism and may include such known features as one or more orifices which may regulate the amount and/or flowrate of concentrate that is drawn into second fluid-flow passage 40 for a given flowrate of diluent, and the like. The connection between concentrate inlet 41 of device 1 and a concentrate reservoir may also include features such as check valves and the like which may serve to prevent backflow into the reservoir. (Connections with features of this type are described e.g. in U.S. Pat. No. 5,988,456). Provision may also be made for venting of the concentrate reservoir so that air can ingress into the concentrate reservoir as concentrate is removed in operation of device 1. Such venting can be arranged such that air may enter the concentrate reservoir but such that liquids (e.g., concentrate) may not easily pass outward through the vent(s). This may be achieved e.g. through the use of vents comprising very small orifices and/or comprising a tortuous path, vents comprising generally air-permeable/liquid-impermeable membranes, and so on. The concentrate reservoir may be securely attached to main body 20 of device 1 by any suitable attachment mechanism.

Often, device 1 may be configured with the longitudinal axis of main body 20 oriented generally horizontally and with a concentrate reservoir positioned generally beneath device 1. Those of skill in the art will appreciate that such devices may however be operated in other positions; however, it should be understood that no matter the orientation of operation, device 1 functions as a venturi-driven device and not as a gravity-feed device.

By diluent is meant any liquid fluid into which it is desired to mix a concentrate so as to form a diluted fluid. Often, the diluent is so-called tap water as found in households, businesses, and the like, delivered via water pipes to faucets at a pressure referred to hereafter as tap water pressure. By concentrate is meant any liquid which it is desired to deliver to device 1 in a concentrated form (e.g., for purposes of minimizing shipping costs, shipping volume and the like) and then to be used by an end user in more dilute form. Such a concentrate may comprise a material (e.g., a cleaning reagent) mixed or dissolved at a high concentration in the same type of fluid into which it will be diluted; or, the concentrate may be a second fluid of entirely different composition from the diluent. Often, the concentrate comprises a solution; however, it may in some cases comprise a dispersion or suspension.

Diluent is introduced into first fluid-flow passage 10 of main body 20 of device 1 through diluent inlet 11, shown in simplified representation in FIG. 1. Often, diluent will be brought to diluent inlet 11 by way of external diluent conduit 60 which is fluidly interfaced with diluent inlet 11. By fluidly interfacing of two components it is meant that the components are brought into close proximity and/or contact with each other and are held in that configuration such that fluid may be passed through the interface from one component into the other component without external leakage of fluid. Diluent conduit 60 may be held in place so as to be fluidly interfaced with diluent inlet 11, by attachment means 22 of main body 20 of device 1, which is shown generically in FIG. 1. Those of ordinary skill in the art will recognize that often, the diluent fluid is tap water, and that diluent conduit 60 may be a hose with an externally threaded terminal end. Accordingly, attachment mechanism 22 may in such cases comprise an internally threaded collar that is attached to main body 20 of device 1 in a freely rotatable manner so that it can threadably engage with a threaded coupling of the diluent hose so as to tightly abut a terminal end surface 61 of the diluent hose against a terminal end surface 23 of device 1 that bounds and defines diluent inlet 11 of device 1, so as to achieve the above-described generally leak-free fluid interface. Any suitable attachment mechanism 22 (including clamps, snaps, quick-connects, and the like) may be used, however. Often, a resilient gasket 62 is placed between a terminal end surface 61 of diluent conduit 60 and a terminal end surface 23 of diluent inlet 11, to facilitate the generally leak-free fluid interface.

Diluted fluid may flow through diluted-fluid passage 10 and out of diluted-fluid outlet 12 so as to be directly applied to an object or surface (e.g., as in the case of a conventional sprayer, e.g. for dispensing of diluted fertilizer and the like). Or, diluted fluid may flow out of outlet 12 into a diluted-fluid container in which it can be stored until used. Accordingly, a spray nozzle, a delivery tube, a diluted-fluid container, and so on, may be attached to diluted fluid outlet 12, as desired.

Device 1 may comprise one or more active fluid flow control valves, shown in generic form as valve 21 in FIG. 1. Such valves may be used to actively control the flow of diluent through first fluid-flow passage 10 and/or the flow of diluted fluid out of diluted-fluid outlet 12. Such valves are herein termed active valves, meaning they are actuated, often by hand, by a user of the device (although they may be actuated by machine, e.g., by a mechanism controlled by a software driven algorithm or the like). Such active valves are to be contrasted with the passive valves that are the subject of the present disclosure and that are actuated solely by the pressure developed by the diluent fluid impinging on the valve. Active valves may serve to alter the flow of diluent and/or diluted fluid in an on-off manner; or they may be useable to adjust the flow over a wide variety of flowrates. Such valves may comprise one or more barriers that are slidably movable into and out of the fluid flow path of passage 10, may comprise one or more rotating members containing through-passages which can be brought into and out of alignment with passage 10 as the member is rotated, and so on. Such valves may be actuated by means of rotatable handles affixed to the exterior of main body 20, e.g., as taught in U.S. Pat. No. 7,237,728 and U.S. Pat. No. 7,341,207; or, by means of movable (e.g., depressable) triggers as taught in U.S. Pat. No. 7,025,289, and so on. This list is not meant to be exhaustive, and those of ordinary skill in the art will realize that there are many possible active valving mechanisms and ways to actuate such active valves.

Main body 20 of device 1 may be made of any suitable material. Often, molded plastics, e.g. injection molded plastics, are used in such applications. Ancillary components (e.g., active valve actuators, spray nozzles, threaded collars, dip tubes, handles, covers, and so on) may be attached to main body 20 by way of snap-fitting, or any other suitable attachment method.

As disclosed herein, device 1 comprises passive pressure-compensating valve 70 in fluid passage 10 in the path of the diluent fluid. Passive valve 70 serves the function of compensating for variations in the pressure at which the diluent fluid is delivered to diluent inlet 11 of device 1 by diluent conduit 60. In the case where the diluent is tap water, it is well known that, e.g. as delivered by municipal water systems, the pressure at the tap can vary over considerable ranges, e.g. from about 20 psi to about 100 psi or more. Such variations can affect the rate at which water is delivered through a particular tap. Thus, passive valves of the type described herein have been used previously in gravity-fed dispensing and mixing systems, e.g. as described in U.S. Pat. No. 5,425,404. In gravity-fed systems, the delivery rate of a concentrate is typically independent of the flowrate of the tap water diluent and no mechanism may exist for changing the flowrate of concentrate commensurate with a change in the tap water diluent flowrate. Therefore, those of ordinary skill may recognize the importance, in such gravity-fed systems, of providing pressure compensation such that the concentrate can be accurately mixed with the tap water diluent over a variety of tap water pressures. However, in the present case of mixing and dispensing systems that operate by the venturi principle, in theory the dilution ratio achieved by the system should not be affected nearly as much by variations in tap water pressure. That is, in the case of higher tap water pressure and commensurate higher tap water diluent flowrate, the increased vacuum developed by the venturi effect should result in a correspondingly higher flowrate of concentrate. Thus, in theory it would be expected that, while higher tap water pressure might result in a higher flowrate of diluted fluid, the flowrate of concentrate should increase commensurately and thus the dilution ratio should be relatively unaffected.

In fact, data presented herein in the Examples section (Tables 1 and 3) shows that variations in tap water pressure can have large effects on the dilution ratio achieved by a venturi-type dispensing system. It has further been found that the use of passive valve 70 as described herein can decrease these effects (i.e., can compensate for variations in tap water pressure) to a surprisingly large degree, hence the terming of passive valve 70 as a pressure-compensating valve. Specifically, as evidenced by comparison of Tables 2 and 4 to Tables 1 and 3, passive valve 70 may be able to reduce the standard deviation/coefficient of variation of the dilution ratio, when measured over a wide range of diluent pressures, by up to a factor of about ten, which is an extremely striking and surprising difference. With the use of passive valve 70, this reduction in coefficient of variation may occur over a range of tap water pressure of at least about 20 psi to 100 psi. In addition, the advantageous effects of valve 70 have been found to be operative even when dispensing fluids over very short time frames (e.g., a few seconds), in which transient fluid flow effects might be expected to lead to increased variation in dilution ratio.

Passive valve 70 may be optimally be placed in diluent passage 10 in such a manner as to be supported at least on its downstream side so as to not be dislodged and/or displaced in the direction of diluent fluid flow. Thus, passive valve 70 may be placed e.g. against a radial shoulder formed in diluent passage 10 (e.g., of the general type of shoulder 14 of FIG. 1). Alternatively, passive valve 70 may be placed within one or more retainers to assist in the holding of valve 70 in place in diluent passage 10. In general, passive valve 70 is positioned such that the entirety of the flowing diluent stream within diluent passage 10 encounters valve 70, regardless of the flowrate of the diluent, such that valve 70 can perform its pressure-compensating function regardless of the diluent flowrate.

An exemplary pressure-compensating passive valve 70 is shown in further detail in FIG. 2. In the illustrated embodiment, passive valve 70 comprises a generally circular shape. However, other configurations are possible, in which case the design e.g. of the cross sectional shape of fluid-flow passage 10 and/or of retainers 80 and 90 discussed later herein can be suitably arranged. Thus as used herein, terms like radial and the like should be interpreted not as applying only to strictly circular shapes, but applying in general. Terms such as upstream face and downstream face are also used to describe passive valve 70; however, in many embodiments valve 70 is symmetrical thus such designations may only apply when valve 70 is actually positioned within diluent passage 10.

In the illustrated embodiment, passive valve 70 is positioned in diluent passage 10 with its longest dimensions (e.g., its radial dimensions) generally transverse to the flow of diluent. That is, passive valve 70 may be somewhat thinner in the fluid flow-path direction than it is in the radial direction generally transverse to the flow path. Passive valve 70 comprises at least one internal through-hole 71 through which diluent can pass (with the term internal through-hole meaning that the hole passes through valve 70 from upstream surface 72 to downstream surface 73 and that the through-hole is radially bounded on all sides by material of valve 70). In various embodiments, passive valve 70 comprises at least about one, two, or three internal through-holes 71. In further embodiments, passive valve 70 comprises at most about nine, seven or five internal through-holes 71. Passive valve 70 may also comprise a number of external through-passages 77, which may be spaced around outer perimeter 75 of valve 70. In the exemplary embodiment of FIG. 2, external through-passages 77 are provided by way of providing radially outwardly extending lobes 76 that, upon insertion of passive valve 70 into the flow path, will contact an adjacent surface (either of fluid-flow passage 10 or of an inner surface of retainer 80 discussed later herein). External through-passages 77 will thus each comprise a small gap circumferentially extending partially around perimeter 75 of passive valve 70, through which a small amount of diluent may be able to pass. However, without wishing to be limited by theory or mechanism, it is believed that the primary flow-restricting effect of passive valve 70 upon exposure to higher diluent fluid pressure is by the restriction of internal through-holes 71 due to deformation (e.g., bowing) of passive valve 70 in a direction aligned with the diluent flow. As shown in the exemplary design of FIG. 2, perimeter 75 of passive valve 70 may be wider in the thickness direction of valve 70 (the direction of fluid flow through valve 70) than is the radially inner portion of valve 70 in which through-holes 71 are placed. This design may enhance the ability of the radially inner portion of valve 70 containing through-holes 71 to bow in response to the diluent pressure so as to achieve the desired pressure-compensating effect.

In some embodiments, passive valve 70 is self-actuating. By this is meant that an increase in force applied to upstream face 72 of valve 70 as result of a sufficient increase in the pressure at which diluent is supplied to device 1, will cause deformation of valve 70 such that the flowrate of diluent is reduced in comparison to what the flowrate of diluent would be in the absence of the deformation, the deformation occurring without the necessity of valve 70 interacting with any other component of device 1 except for such interaction as is needed to hold valve 70 in position in the diluent flow path. That is, self-actuating passive valve 70 is not required to interact e.g. with the fine-scale surface structure of an adjacent component (separate from valve 70) of device 1 in order to function. The term self-actuating therefore serves to differentiate this particular embodiment of passive valve 70 from such deformable or resilient flow control elements as are required e.g. to expand so as to partially fill grooves in an adjacent surface of a separate collar so as to function.

The positioning of passive valve 70, e.g. self-actuating passive valve 70, in diluent passage 10 may be achieved in any suitable manner, it merely being required that valve 70 is positioned such that the flowing diluent encounters (e.g., impinges upon) valve 70 in such a manner as to allow valve 70 to function as described herein. In some embodiments this may be performed by positioning passive valve 70 in a section of diluent passage 10 that is radially sized such that an interference fit is provided between inner surface 13 of diluent passage 10 and radially-outward facing surface 78 of perimeter 75 of valve 70. In some embodiments an upstream-facing shoulder (akin to shoulder 14) may be provided in diluent passage 10, against which a radially outer portion of downstream surface 73 of valve 70 can rest. In such a design the pressure of the diluent fluid may assists in holding passive valve 70 in position against the upstream-facing surface of the shoulder. In other embodiments, passive valve 70 may be retained in position by one or more retainers, as discussed in detail later herein.

In some embodiments passive valve 70 comprises a single, integral piece (i.e., all of the components of valve 70 are comprised of a single piece of material of the same composition, made at the same time, e.g. by molding). In further embodiments, passive valve 70 comprises a single, integral piece that is made of a reversibly deformable material. In various embodiments, such material may comprise an elastomer with a Shore A hardness of from about 50 to about 90 or from about 60 to about 80. Elastomers with a Shore A hardness of around 70 have been found to be particularly suitable, for example. Passive valve 70 may be conveniently made by injection molding of a suitable thermoplastic elastomer (e.g., ethylene-propylene rubber) and the like.

In use with certain conventional venturi-type dispensers operating with tap water as diluent, it has been found convenient to use passive valves 70 of diameter of about 11 mm. In various embodiments, internal through-holes 71 may be at least about 0.4 mm, 0.8 mm or 1.2 mm in diameter. In further embodiments, internal through-holes 71 may be at most about 2.2, 2.0, or 1.8 mm in diameter. In various embodiments, external through-passages 77 may comprise recesses (e.g., in between protruding lobes 76) that each circumferentially extend about 3, 4 or 5 mm around perimeter 75 of passive valve 70, and that are each in the range of 0.4 to 1.5 mm in radial depth. Any or all of these parameters, as well as the hardness of the material comprising valve 70, may be adjusted as desired for a given dispensing apparatus and application.

As mentioned, passive valve 70 may be placed directly into diluent passage 10, e.g. with the radially outermost portion of downstream surface 73 of valve 70 resting against shoulder 14 of diluent passage 10. However, it has been found convenient to provide passive valve 70 partially contained within retainer 80, as shown in an exemplary manner in FIGS. 1 and 2. Retainer 80 may be made of a generally rigid material and may comprise generally smooth surfaces (e.g., it may be molded from any convenient injection molding resin that hardens to form a generally rigid material). As shown in FIG. 2, retainer 80 comprises an open end 86 into which passive valve 70 may be inserted so as to reside and which faces upstream upon insertion of retainer 80 and valve 70 into diluent passage 10. Retainer 80 comprises a downstream face 82 with an upstream surface 84 against which at least a portion of downstream surface 73 of passive valve 70 may reside, and a downstream surface 83 a radially outermost portion of which may reside against shoulder 14 of diluent passage 10 (all as shown in FIGS. 1 and 2). Downstream face 82 comprises at least one through-hole 85 through which diluent may pass. Retainer 80 further comprises a collar 81 that, upon insertion of passive valve 70 into retainer 80, is positioned outwardly radially adjacent to perimeter 75 and lobes 76 and external through-passages 77 thereof.

If desired, retainer 80 with passive valve 70 inserted therein can be placed into diluent passage 10 of device 1. However, it has been found convenient to use a second retainer 90 that works in a complementary manner with first retainer 80 to hold passive valve 70, as shown in an exemplary manner in FIGS. 1 and 2. Second retainer 90 comprises a collar 91 sized such that upon insertion of retainer 80 into open end 94 of retainer 90, outer surface 87 of collar 81 of retainer 80 forms an interference fit with inner surface 95 of collar 91 of retainer 90. At the end opposite open end 94, retainer 90 comprises flange 92 radially surrounding through-hole 93. When in position in diluent passage 10, through-hole 93 will face upstream and will admit diluent flow to upstream surface 72 of passive valve 70. If desired, the radially inner edge of flange 92 may be radiused (as shown in FIG. 2). In use, passive valve 70 may be inserted into open end 86 of retainer 80, and retainer 80 may be then inserted into open end 94 of retainer 90. Retainer 90 and retainer 80, with passive valve 70 held therebetween, may then be placed into diluent passage 10 such that a radially outermost portion of downstream surface 83 of retainer 80 resides against shoulder 14 of diluent passage 10. Collar 91 of retainer 90 may be sized such that there is a slight interference fit between outer surface 97 of collar 91 of retainer 90, and the inner-facing surface of a portion of diluent passage 10 upstream from shoulder 14 of diluent passage 10.

Passive valve 70 and retainers 80 and 90 thus may collectively comprise module 30 which may easily and straightforwardly be placed in position in diluent passage 10. Thus for ease of placement and replacement, passive valve 70 may be supplied to an end user as part of module 30 if desired. Module 30 may be held in position via an interference fit as described herein, or by any other suitable attachment method. Upon attachment of diluent conduit 60 to diluent inlet 11, a terminal end surface 61 of diluent conduit 60 may contact a portion of module 30, which may enhance the secure holding of module 30 in place. If resilient gasket 62 is present, a portion of gasket 62 may contact (e.g., press against) a portion of module 30, e.g. the upstream face of flange 92 of retainer 90, to enhance the holding of module 30 in place.

In some embodiments, passive valve 70 (whether self-actuating or not) may be placed in diluent passage 10 in a location proximal to diluent inlet 11 of diluent passage 10, e.g. as shown in FIG. 1. By positioning passive valve 70 proximal to diluent inlet 11 is meant that there is no other fluid flow control element (e.g., an active flow control valve, a backflow preventer, etc.), present in diluent passage 10 between passive valve 70 and diluent inlet 11. By positioning passive valve 70 proximal to diluent inlet 11 is further meant that passive valve 70 is not positioned within, and is not a part of, any type of active valve or flow control device. By proximal to diluent inlet 11 is still further meant that valve 70 is accessible through diluent inlet 11 such that valve 70 can be removed through diluent inlet 11 (e.g., after decoupling diluent conduit 60 from diluent inlet 11) without requiring any disassembly of main body 20 or ancillary components thereof. Thus, in this context passive valve 70 is replaceable, meaning that valve 70 can be straightforwardly removed by an end-user through diluent inlet 11, and can then be replaced by a replacement valve 70 if desired. In some embodiments, valve 70 is line-of-sight visible through diluent inlet 11, such that at least portions of valve 70 may be easily inspected such that it can be determined whether some internal through-holes 71 of valve 70 may have become plugged with debris. As such, valve 70 as disclosed herein is advantageous in that it can easily be inspected and/or removed and replaced if an end user desires, without necessitating that device 1 be disassembled or returned to the factory.

Passive valve 70, thus placed in proximity to diluent inlet 11, may be a self-actuating passive valve as described herein. Passive valve 70 may be placed in proximity to diluent inlet 11 as part of module 30 in which valve 70 is held within retainers 80 and 90, as described herein.

Passive valve 70 may be particularly advantageous in the dilution of concentrates that comprise a relatively high vapor pressure (e.g., higher than that of water at room temperature) and that accordingly are difficult to dispense with conventional gravity-feed mixing/dispensing units. Such concentrates may include e.g. peroxyacetic acid.

### EXAMPLES

The tests and test results described above are intended solely to be illustrative, rather than predictive, and variations in the testing procedure can be expected to yield different results. All quantitative values in the Examples section are understood to be approximate in view of the commonly known tolerances involved in the procedures used. The foregoing detailed description and examples have been given for clarity of understanding only. No unnecessary limitations are to be understood therefrom.

Venturi-type diluting dispensers were obtained from RD Industries, Omaha, Nebr., under the designation Portable Dispensing Unit. The dispensers comprised a concentrate inlet with a “yellow-tip” orifice (of diameter approximately 0.0159 inch). The dispensers were adjustable for delivery of diluent at high-flow and low-flow settings, and were set at high flow.

Experiments were performed with a dispenser as received (results shown in Tables 1 and 3). Experiments were also performed (results shown in Tables 2 and 4) with a dispenser containing a passive self-actuating pressure compensation valve of the exemplary design of valve 70 shown in FIG. 2. The valve was made of molded ethylene-propylene rubber resin with a Shore hardness of approximately 70. The valve was approximately 11 mm in nominal diameter and approximately 4 mm in nominal thickness. The valve comprised three interior through-holes each with a diameter of approximately 1.68 mm. The valve was placed inside a first retainer of the design shown herein as retainer 80 of FIG. 2, with a collar of ID approximately 12 mm and OD approximately 15 mm, and with an internal depth (into which the valve was inserted) of approximately 6 mm. The end of the first retainer that would become the downstream end upon insertion into the diluent path comprised a flange circumscribing a generally circular opening, centered in the downstream end, of diameter approximately 4 mm. The first retainer with the valve therein was then inserted, open end of the retainer first, into the open end of a second, complementary retainer. The second retainer was of the design shown herein as retainer 90 of FIG. 2. The second retainer had a collar with an ID of approximately 15 mm (such that a slight interference fit was obtained between the inner surface of the collar of the second retainer and the outer surface of the collar of the first retainer), an OD of approximately 17 mm, and an internal depth (into which the first retainer with the valve therein was inserted) of approximately 7 mm. The end of the second retainer that would become the upstream end upon insertion into the diluent flow path comprised a flange of radial thickness approximately 3 mm, circumscribing an opening of approximately 11 mm.

In the manner described herein the valve and retainers were thus assembled into a module which could be handled as a unit. The module was placed into the diluent inlet of the RD Industries Portable Dispensing Unit (dispenser), with the radially outer portions of the flange of the downstream end of the first retainer positioned against a shoulder that was present in the diluent passage approximately 10 mm downstream from the diluent inlet. The portion of the diluent passage upstream from the shoulder comprised an ID of approximately 17 mm, such that a slight interference fit was obtained between the outer surface of the collar of the second retainer and the inner surface of the diluent passage.

A concentrate reservoir (supplied with the dispenser) was filled with tap water and was connected and secured to the concentrate inlet of the dispenser. A tap water hose was connected to the diluent inlet of the dispenser and was secured thereto (by the threaded collar of the dispenser) with a resilient gasket with a large central through-hole, present between the terminal surface of the diluent inlet and the terminal surface of the water hose. Tap water was supplied to the water hose at various pressures, as disclosed herein.

In performing a dilution experiment, an amount of tap water was admitted into the diluent inlet at a given pressure and “concentrate” water was thereby caused by the venturi effect to be drawn up the concentrate inlet and to be mixed with the diluent water. The dispensed “diluted” fluid emitted through the diluted-fluid outlet of the dispenser was captured in a receiving container. The total weight of dispensed fluid in the receiving container was measured. The weight of concentrate fluid that had been removed from the concentrate reservoir during the dispensing process was obtained by way of measuring the weight of the concentrate reservoir and contents thereof before and after the dispensing process. The dilution ratio was then obtained as the ratio of the weight of the total dispensed fluid to the weight of the concentrate fluid in the dispensed fluid. The mean, standard deviation and coefficient of variation were calculated.

Experiments were run in which the dispensed fluid was captured in a large bucket (Tables 3 and 4), thus allowing samples to be dispensed in the range of several kilograms. Experiments were also run in which the dispensed fluid was captured in a small bottle (Tables 1 and 2), in which case the dispensed samples were typically less than one kilogram. In the latter case, the time for dispensing the sample volume was typically in the range of 5-7 seconds.

TABLE 1
Small sample volume, passive valve not present

| Diluent Pressure | Total Fluid | Concentrate | Dilution |
|---|---|---|---|
| (psi) | Dispensed (g) | Dispensed (g) | Ratio |
| 20 | 929 | 6.7 | 138 |
| 25 | 918 | 6.9 | 132 |
| 30 | 946 | 8.0 | 117 |
| 40 | 861 | 7.3 | 117 |
| 50 | 763 | 6.1 | 124 |
| 60 | 898 | 6.8 | 131 |
| 70 | 840 | 6.0 | 139 |
| 80 | 856 | 5.8 | 147 |
| 90 | 835 | 5.5 | 151 |
| 100 | 801 | 5.1 | 156 |

The dilution ratio had a mean of 135.2 and a standard deviation of 13.6, resulting in a coefficient of variation of 10.04%.

TABLE 2
Small sample volume, passive valve present

| Diluent Pressure | Total Fluid | Concentrate | Dilution |
|---|---|---|---|
| (psi) | Dispensed (g) | Dispensed (g) | Ratio |
| 20 | 921 | 6.4 | 143 |
| 25 | 923 | 6.5 | 141 |
| 30 | 923 | 6.5 | 141 |
| 40 | 929 | 6.6 | 140 |
| 50 | 920 | 6.6 | 138 |
| 60 | 921 | 6.5 | 141 |
| 70 | 917 | 6.6 | 138 |
| 80 | 922 | 6.7 | 137 |
| 90 | 933 | 6.7 | 138 |
| 100 | 925 | 6.6 | 139 |

The dilution ratio had a mean of 139.6 and a standard deviation of 1.90, resulting in a coefficient of variation of 1.36%.

TABLE 3
Large sample volume, passive valve not present

| Diluent Pressure | Total Fluid | Concentrate | Dilution |
|---|---|---|---|
| (psi) | Dispensed (g) | Dispensed (g) | Ratio |
| 20 | 8605 | 61.3 | 139 |
| 25 | 9595 | 73.4 | 130 |
| 30 | 9941 | 80.5 | 122 |
| 40 | 10974 | 91.1 | 119 |
| 50 | 11951 | 91.3 | 130 |
| 60 | 12680 | 91.0 | 138 |
| 70 | 13504 | 91.1 | 147 |
| 80 | 14165 | 91.1 | 154 |
| 90 | 14719 | 91.1 | 161 |
| 100 | 15141 | 90.2 | 167 |

The dilution ratio had a mean of 140.7 and a standard deviation of 16.3, resulting in a coefficient of variation of 11.6%.

TABLE 4
Large sample volume, passive valve present

| Diluent Pressure | Total Fluid | Concentrate | Dilution |
|---|---|---|---|
| (psi) | Dispensed (g) | Dispensed (g) | Ratio |
| 20 | 5487 | 37.9 | 144 |
| 25 | 5618 | 38.6 | 145 |
| 30 | 5976 | 41.2 | 144 |
| 40 | 6580 | 46.2 | 141 |
| 50 | 6711 | 46.9 | 142 |
| 60 | 6986 | 48.8 | 142 |
| 70 | 7006 | 49.0 | 142 |
| 80 | 6990 | 48.3 | 144 |
| 90 | 6954 | 48.1 | 144 |
| 100 | 6633 | 46.0 | 143 |

The dilution ratio had a mean of 143.1 and a standard deviation of 1.29, resulting in a coefficient of variation of 0.90%.

It will be apparent to those skilled in the art that the specific exemplary structures, features, details, configurations, etc., that are disclosed herein can be modified and/or combined in numerous embodiments. All such variations and combinations are contemplated by the inventor as being within the bounds of the conceived invention. Thus, the scope of the present invention should not be limited to the specific illustrative structures described herein, but rather by the structures described by the language of the claims, and the equivalents of those structures. To the extent that there is a conflict or discrepancy between this specification and the disclosure in any document incorporated by reference herein, this specification will control.

What is claimed is:

1. A diluted-fluid dispensing device comprising:
a first fluid-flow passage fluidly connecting a diluent inlet to a diluted-fluid outlet;
a second fluid-flow passage intersecting with the first fluid-flow passage and fluidly connecting a concentrate inlet to the intersection of the second fluid-flow passage with the first fluid-flow passage;
wherein the first and second fluid-flow passages collectively form a venturi;
and wherein the first fluid-flow passage comprises a self-actuating passive pressure-compensating valve.

2. The device of claim 1 wherein the valve is comprised of a reversibly deformable elastomeric material and comprises at least one internal through-hole permitting the passage of diluent through the valve.

3. The device of claim 2 wherein the valve is comprised of a single piece of molded elastomeric material with a Shore A hardness of from about 60 to about 80.

4. The device of claim 1 wherein the valve is removable and replaceable without disassembly of the device.

5. The device of claim 1 wherein the first fluid-flow passage comprises a shoulder with an upstream-facing surface arranged to contact a radially outermost portion of a downstream face of the valve; and wherein the first fluid-flow passage further comprises, adjacent the shoulder and between the shoulder and the diluent inlet, a section of the first fluid-flow passage sized to receive a radially-outermost perimeter surface of the valve with an interference fit.

6. The device of claim 1 wherein the valve is retained within a first retainer with an upstream open end, a downstream end with a face comprising an opening, and a collar connecting the downstream end to the upstream end.

7. The device of claim 6 wherein the valve and the first retainer are retained within a second retainer comprising a downstream open end, an upstream end with a face comprising an opening, and a collar connecting the downstream end to the upstream end, the collar of the second retainer being sized to reside outside the collar of the first retainer.

8. The device of claim 7 wherein the collar of the second retainer comprises an inner surface sized to provide an interference fit with an outer surface of the collar of the first retainer.

9. The device of claim 8 wherein the valve and the first and second retainers are provided together as a removable module.

10. The device of claim 7 wherein the first fluid-flow passage comprises a shoulder with an upstream-facing surface arranged to contact a radially outermost portion of the downstream face of the first retainer; and wherein the first fluid-flow passage further comprises, adjacent the shoulder and between the shoulder and the diluent inlet, a section of the first fluid-flow passage sized to receive an outer surface of the collar of the second retainer with an interference fit.

11. The device of claim 7 wherein the diluent inlet is fluidly interfaced to a diluent conduit, with a resilient gasket positioned at the fluid interface in between the diluent inlet of the fluid dilution device and a terminal end of the diluent conduit, and wherein the resilient gasket comprises a downstream face that presses against a portion of the upstream face of the second retainer to hold the retainers and the valve in position in the first fluid-flow passage.

12. The device of claim 1 wherein the device is arranged to receive diluent over a range of diluent flowrates and wherein the valve is arranged in the first fluid-flow passage so that the entirety of the flowing diluent within the first fluid-flow passage encounters the valve, regardless of the flowrate of the diluent.

13. The device of claim 1 wherein the device is arranged to receive diluent over a pressure range of at least 20 to 100 psi, and wherein the valve is arranged to provide pressure compensation over the entirety of the pressure range.

14. The device of claim 13 wherein the valve provides pressure compensation such that over a diluent pressure range of 20 to 100 psi, a dilution ratio of dispensed concentrate to total dispensed fluid is achieved with a coefficient of variation of less than about 1.5%.

15. A diluted-fluid dispensing device comprising:
a first fluid-flow passage fluidly connecting a diluent inlet to a diluted-fluid outlet;
a second fluid-flow passage intersecting with the first fluid-flow passage and fluidly connecting a concentrate inlet to the intersection of the second fluid-flow passage with the first fluid-flow passage;
wherein the first and second fluid-flow passages collectively form a venturi;
and wherein the first fluid-flow passage comprises a passive pressure-compensating valve in a location proximal to the diluent inlet.

16. The fluid dilution device of claim 15 wherein the valve is a self-actuating valve.

17. The device of claim 15 wherein when the device is not connected to a diluent fluid conduit at least a portion of an upstream face of the valve is line-of-sight visible through the diluent inlet.

18. The device of claim 17 wherein the valve is removable and replaceable without disassembling the device.

19. The device of claim 15 wherein the valve is comprised of a reversibly deformable elastomeric material and comprises at least one internal through-hole permitting the passage of diluent through the valve.

20. The device of claim 19 wherein the valve is retained within a first retainer with an upstream open end, a downstream end with a face comprising an opening, and a collar connecting the downstream end to the upstream end, and wherein the valve and the first retainer are retained within a second retainer comprising a downstream open end, an upstream end with a face comprising an opening, and a collar connecting the downstream end to the upstream end, the collar of the second retainer being sized to reside outside the collar of the first retainer.
